(19) United States
(12) Patent Application Publication
(10) Pub. No.: US 2011/0013700 A1
(43) Pub. Date: Jan. 20, 2011

(54) METHOD AND APPARATUS FOR CODING AND DECODING COLOR CHANNELS IN LAYERED VIDEO CODING AND DECODING

(75) Inventor: Dae-Hee KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/839,552

(22) Filed: Jul. 20, 2010

(30) Foreign Application Priority Data
Jul. 20, 2009 (KR) 10-2009-0066100

(51) Int. Cl. H04N 7/26

(52) U.S. Cl. 375/240.18; 375/E07.226

(57) ABSTRACT

A method and apparatus for coding a color channel in a layered video coder are provided. According to the method and apparatus, if there is at least one color channel that can be skipped during coding of the color channel, a Coded Significant Pattern (CSP) of a macro block, which represents a structure of the color channel, is converted into a CSP with a structure in which the at least one color channel is skipped, and a significant transform coefficient of the macro block is coded using the CSP represented in the structure in which the at least one color channel is skipped.

### CROSS-REFERENCE TO RELATED APPLICATION

This application claims priority from Korean Patent Application No. 10-2009-0066100, filed in the Korean Intellectual Property Office on Jul. 20, 2009, the disclosure of which is hereby incorporated by reference in its entirety.

### BACKGROUND

1. Field

Apparatuses and methods consistent with exemplary embodiments relate tocoding and decoding images, and more particularly, to coding and decoding color channels in layered video coding and decoding, also known as hierarchical video coding and decoding.

2. Description of the Related Art

A YUV scheme is one of the schemes for representing color channels in image processing. The YUV scheme is a color representation scheme based on the fact that the human eye is sensitive to luminance rather than chrominance. In the YUV scheme, colors are divided into luminance components and chrominance components during their processing, and the luminance components are defined as Y components while the chrominance components are defined as U and V components. Being sensitive to errors, the Y components generally need coding of more bits than the U and V components representing chrominance.

If the Y components and the U and V components are classified into color channels, the Y components representing luminance correspond to luma channels while the U and V components representing chrominance (i.e., color differences) correspond to chroma channels. The Y, U and V components may be called Y, U and V channels, respectively.

Images are coded and decoded in units of, for example, 16×16 pixel blocks which are spatially defined as macro blocks. The macro block generally consists of four 8×8 pixel blocks. For example, if a chroma format of an original image is 4:2:2, one macro block may consist of a total of eight channel blocks: four Y channel blocks, two U channel blocks and two V channel blocks. The Y channel blocks correspond to luminance blocks, while the U and V channel blocks correspond to chrominance blocks (i.e., color difference blocks). In addition, the Y channel blocks consist of upper blocks and lower blocks. The upper and lower blocks each consists of two blocks, and the U and V channel blocks also each consists of two blocks.

Generally, for image coding and decoding, image processing is performed on a macro block basis, and during the image processing, the above color channels are coded and decoded. In one macro block, all color channels consist of a plurality of blocks representing luminance and chrominance as described above. However, since this method uses a scheme of coding and decoding the entire image in each of a basement layer and an enhancement layer, the related art layered video coding/decoding technology codes and decodes all color channels constituting luma channels and chroma channels (i.e., color difference channels) of the images.

In this case, however, not only the used color channels but also the unused color channels are coded and decoded, increasing complexity during coding/decoding of color channels. Therefore, a more efficient color channel coding/decoding approach is needed.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

Exemplary embodiments provide a method and apparatus for efficiently coding and decoding color channels in layered video coding and decoding.

Exemplary embodiments also provide a method and apparatus for selectively coding and decoding color channels in layered video coding and decoding.

In accordance with an aspect of an exemplary embodiment, there is provided a method for coding a color channel in a layered video coder, the method comprising: if there is at least one color channel that can be skipped during coding of the color channel, converting a Coded Significant Pattern (CSP) of a macro block, which represents a structure of the color channel, into a CSP with a structure in which the at least one color channel is skipped; and coding a significant transform coefficient of the macro block using the CSP represented in the structure in which the at least one color channel is skipped.

In accordance with an aspect of another exemplary embodiment, there is provided an apparatus for coding a color channel in a layered video coder, the apparatus comprising: a Coded Significant Pattern (CSP) converter which, if there is at least one color channel that can be skipped during coding of the color channel, converts a CSP of a macro block, which represents a structure of the color channel, into a CSP with a structure in which the at least one color channel is skipped; and a significant transform coefficient coder which codes a significant transform coefficient of the macro block using the CSP represented in the structure in which the at least one color channel is skipped.

In accordance with an aspect of another exemplary embodiment, there is provided a method for decoding a color channel in a layered video decoder, the method comprising: if at least one skipped color channel is detected from a received image, restoring a Coded Significant Pattern (CSP) of a macro block, which represents a structure of the color channel, into a CSP with a structure in which the at least one color channel is skipped; and decoding a significant transform coefficient of the macro block using the restored CSP.

In accordance with an aspect of another exemplary embodiment, there is provided an apparatus for decoding a color channel in a layered video decoder, the apparatus comprising: a Coded Significant Pattern (CSP) restorer which if at least one skipped color channel is detected from a received image, restores a CSP of a macro block, which represents a structure of the color channel, into a CSP with a structure in which the at least one color channel is skipped; and a significant transform coefficient decoder which decodes a significant transform coefficient of the macro block using the restored CSP.

### BRIEF DESCRIPTION OF THE DRAWINGS

The above and/or other aspects will be more apparent by describing certain exemplary embodiments with reference to the accompanying drawings, in which:

FIG. 1 is a block diagram showing a structure of an image coding apparatus for selectively coding color channels according to an exemplary embodiment;

FIG. 2 is a block diagram showing a structure of an image decoding apparatus for selectively decoding color channels according to an exemplary embodiment;

FIG. 3 is a block diagram showing a structure of a color channel coder according to an exemplary embodiment;

FIG. 4 is a block diagram showing a structure of a color channel decoder according to an exemplary embodiment;

FIG. 5 is a diagram showing a CSP representation structure in which all CSPs are hierarchically constructed from a macro block level (MB-level) according to an exemplary embodiment; and

FIGS. 6, to 17 are diagrams showing various examples of a CSP representation structure according to an exemplary embodiment.

### DETAILED DESCRIPTION OF EXEMPLARY EMBODIMENTS

Certain exemplary embodiments are described in detail below with reference to the accompanying drawings.

In the following description, like drawing reference numerals are used for the like elements, even in different drawings. The matters defined in the description, such as detailed configuration and components are provided to assist in a comprehensive understanding of exemplary embodiments. However, exemplary embodiments can be practiced without those specifically defined matters.

Exemplary embodiments provide a color channel coding/decoding method for selectively coding and decoding only selected color channels in a layered video coder/decoder which converts pictures reconstructed by a basement layer coder into pictures corresponding to an enhancement layer, and coding and decoding differences between the basement layer pictures and the enhancement layer pictures. In an exemplary embodiment, the layered video coder/decoder selectively codes and decodes only some actually used color channels. If at least one unused color channel is skipped or omitted from the color channels representing an enhancement layer picture, this color channel is not coded/decoded.

In this regard, a related art color channel representation scheme for color channel coding/decoding uses a scheme of representing the presence or absence of transform coefficients such as quantization coefficients for macro blocks or unit blocks of a predetermined size, using Coded Block Pattern (CBP) parameters. When representing an image during image coding, the related art color channel representation scheme using the CBP parameters codes and transmits all of the color channels, including the unused color channels.

To improve the related art scheme, an exemplary embodiment selectively codes and decodes only some actually used color channels among all color channels for representing the picture in the enhancement layer. For example, an exemplary embodiment defines a CSP having a representation structure capable of dynamically responding according to the selection of some color channels and the form of transform coefficients during coding/decoding, and proposes a new color channel representation scheme of coding transform coefficients of macro blocks using the CSP, and a color channel coding/decoding scheme using the same. In an exemplary embodiment, the transform coefficients of macro blocks are coded using the CSP with the structure capable of dynamically coping with the selection of some color channels (in other words, omission of unused color channels) and the form of transform coefficients. A transform coefficient having a value of 1 or more is referred to as a significant transform coefficient.

In an exemplary embodiment, only a color channel used during image coding/decoding is coded and transmitted according to the use/nonuse or the presence/absence of each color channel among all color channels in an enhancement layer picture. If at least one color channel is skipped or omitted during coding, this color channel is omitted during color channel decoding, thereby facilitating efficient coding/decoding of color channels in the enhancement layer.

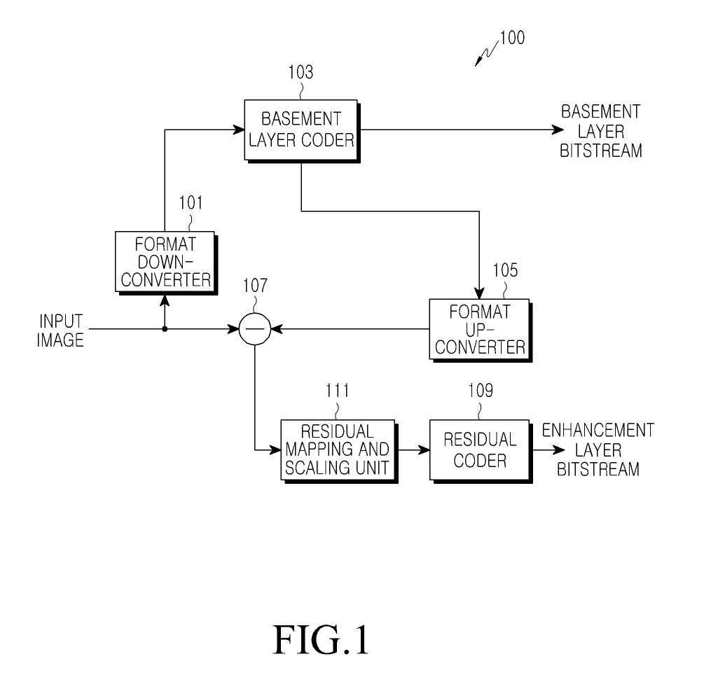

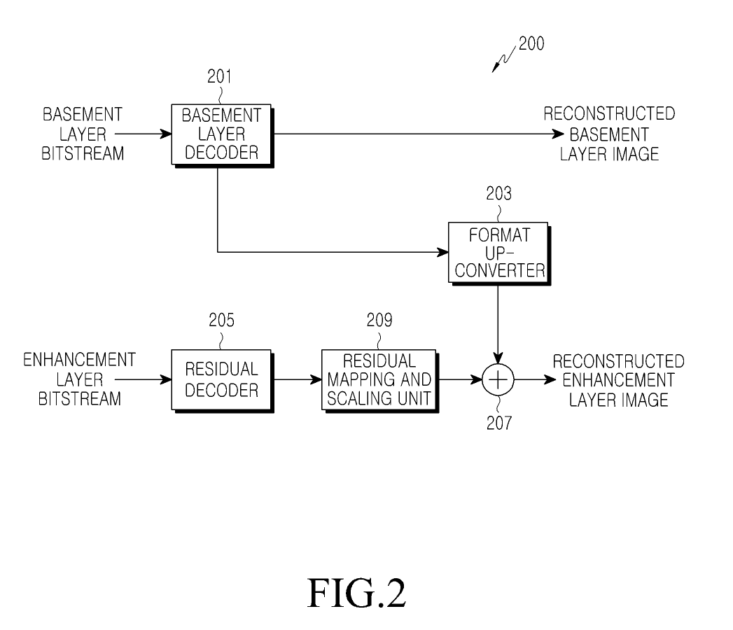

A selective color channel coder/decoder according to an exemplary embodiment may be used in a layered video coder of FIG. 1 and a layered video decoder of FIG. 2 for decoding bitstreams output from the layered video coder.

FIG. 1 shows a structure of a layered video coder embodied in an image coding apparatus 100 for selectively coding color channels according to an exemplary embodiment.

The image coding apparatus 100 is adapted to convert an picture restored or reconstructed from a coded basement layer picture into an enhancement layer picture, and to code a difference (residual) between the input enhancement layer picture and the picture reconstructed from the basement layer picture. The image coding apparatus 100 of FIG. 1 codes an input image and outputs a basement layer bitstream and an enhancement layer bitstream. The basement layer picture and the enhancement layer picture may have different resolutions, image sizes, or views.

For example, the input image and the image processed in the enhancement layer have a high resolution, a large size, or one view, while the image processed in the basement layer has a low resolution, a small size, or another view. A format down-converter 101 down-converts an input image into a video format of the basement layer. The format down-converter, for example, converts the input video format into one of a lower resolution, a smaller bit depth, and a reduced chroma format, or a combination thereof. A basement layer coder 103 codes an input basement layer picture according to a coding scheme using an image coder based video codecs such as, for example, VC-1, H.264, MPEG-4 Part 2 Visual, MPEG-2 Part 2 Video, AVS, or JPEG2000, and outputs a basement layer bitstream.

The basement layer coder 103 outputs the basement layer picture reconstructed in the basement layer image coding process, to a format up-converter 105. The format up-converter 105 up-converts the reconstructed basement layer picture into a video format of the enhancement layer. The format up-converter, for example, converts the reconstructed basement layer picture into any one of a higher resolution, a larger bit depth, and an extended chroma format, or a combination thereof. The input image being input to the format down-converter 101 is input to a subtractor 107 as well. The subtractor 107 outputs a residual picture by subtracting the format up-converted image from the input image. A residual coder 109 codes the input residual picture and outputs an enhancement layer bitstream. The residual picture output from the subtractor 107 is converted into a predetermined number of bits through linear scaling by a residual mapping and scaling unit 111.

A color channel coder 300 of an exemplary embodiment converts an MB-level CSP for the case where a color channel is omitted, into a CSP with a reduced structure, in order to represent only the selected color channels (in other words, the color channels left after omitting at least one omissible color channel from all color channels) according to the structure of the color channels. The color channel coder 300 further codes the color channels using the CSP represented in the reduced structure. The color channel coder 300 may be provided as a part of the residual coder 109, or may be included in the image coding apparatus 100 of FIG. 1 as a separate component connected to the residual coder 109. A structure of the color channel coder is described in detail below.

FIG. 2 shows a structure of a layered video decoder embodied in an image decoding apparatus 200 for selectively decoding color channels according to an exemplary embodiment.

The image decoding apparatus 200 is adapted to reconstruct a basement layer bitstream by decoding, to output a reconstructed enhancement layer picture by format up-converting the reconstructed basement layer picture, to restore the residual picture coded in the image coding apparatus 100 of FIG. 1 by residual decoding of the enhancement layer bitstream, and to restore the enhancement layer picture by adding the restored residual picture to the image up-converted from the reconstructed basement layer picture.

The image decoding apparatus 200 of FIG. 2 is constructed in a hierarchical structure including a basement layer processing and an enhancement layer processing, to output a reconstructed basement layer picture and a reconstructed enhancement layer picture by decoding the basement layer bitstream and the enhancement layer bitstream coded by the image coding apparatus 100 of FIG. 1. The basement layer picture and the enhancement layer picture may have different resolutions, image sizes, or views.

A basement layer decoder 201 decodes an input basement layer bitstream using a decoding scheme corresponding to the video codec used in the basement layer coder 103 of FIG. 1, and outputs a reconstructed basement layer picture. The basement layer picture reconstructed by the basement layer decoder 201 is output to a format up-converter 203 as well. The format up-converter 203 up-converts the reconstructed basement layer picture into a video format of the enhancement layer. A residual decoder 205 outputs a residual picture generated by residual decoding of an input enhancement layer bitstream. The decoded residual picture is added to the up-converted image by an adder 207, and then output as a reconstructed enhancement layer picture. The residual picture output from the residual decoder 205 is converted into a predetermined number of bits through linear scaling by a residual mapping and scaling unit 209.

A color channel decoder 400 of an exemplary embodiment restores a CSP with a structure including at least one color channel selected according to the use/nonuse or the presence/absence of color channels, and decodes color channels using the decoded CSP. The color channel decoder 400 may be provided as a part of the residual decoder 205, or may be included in the image decoding apparatus 200 of FIG. 2 as a separate component connected to the residual decoder 205. A detailed structure of the color channel decoder 400 is described in detail below.

When the selective color channel coding/decoding method of an exemplary embodiment is applied to the layered video coder/decoder of FIGS. 1 and 2, it is possible to efficiently compress bitstreams by coding residual images based on a difference between the basement layer and the enhancement layer. Since the selective color channel coding/decoding method may achieve complexity reduction because it does not code some color channels according to selective color channel coding, this method may be used for applications requiring low complexity, such as mobile environments. Besides, the method may selectively transmit only some color channels, thus offering new applications that use only some of the color information.

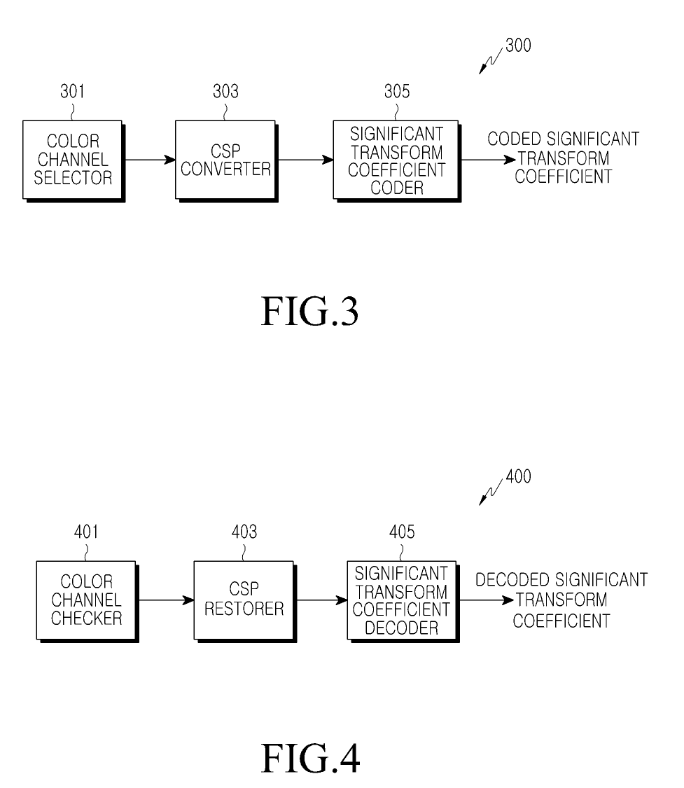

The structures and operations of a color channel coder and a color channel decoder according to an exemplary embodiment is described with reference to FIGS. 3 and 4, respectively.

The color channel coder 300 of FIG. 3 according to an exemplary embodiment is provided as a part of the residual coder 109, or included in the image coding apparatus 100 of FIG. 1 as a separate component, and performs an operation of selecting the actually used color channels, and coding a significant transform coefficient of a macro block using a CSP represented in a reduced structure if an omitted color channel exists due to the selected color channels. The operation of coding a significant transform coefficient of a macro block is equivalent to an operation of coding color channels.

The color channel coder 300 includes a color channel selector 301, a CSP converter 303, and a significant transform coefficient coder 305, to code a CSP corresponding to selected color channels when the image coding apparatus 100 of FIG. 1 codes enhancement layer residual images. The color channel selector 301 selects at least one actually used color channel, omitting unused color channels among all color channels. As a result of the selection, if at least one of a luma channel and a chroma channel is skipped or unused, i.e., if at least one of Y, U and V channels is skipped, this information is provided to a color channel decoder, as described below, through a picture header as channel skip mode information. In an exemplary embodiment, it is assumed that at least one color channel is used.

If an omitted color channel exists due to the selected color channel, the CSP converter 303 converts a CSP of a macro block into a CSP with a structure in which at least one unused color channel is reduced, and outputs the CSP represented in the reduced structure. That is, if there is at least one color channel omissible during coding of the color channel, the CSP converter 303 converts a CSP of a macro block, representing a structure of the color channel, into a CSP with a structure in which at least one color channel is omitted. The significant transform coefficient coder 305 codes the significant transform coefficient of the macro block using the CSP represented in the reduced structure, using one of the related art coding schemes used for entropy coding.

A color channel decoder 400 of FIG. 4 according to an exemplary embodiment performs an operation of restoring a CSP with a structure including at least one color channel selected according to the use/nonuse of color channels, and decoding a significant transform coefficient of a macro block in the enhancement layer using the restored CSP.

The color channel decoder 400 includes a color channel checker 401, a CSP restorer 403, and a significant transform coefficient decoder 405. As a result of the channel selection, if at least one of a luma channel and a chroma channel is skipped, this information is provided in the picture header, for example. The color channel checker 401 checks the channel skip mode information indicating the skip in the picture header, and provides the check results to the CSP restorer 403. The CSP restorer 403 restores a CSP represented in a structure in which at least one unused color channel is reduced, based on the channel skip mode information. The significant transform coefficient decoder 405 decodes the significant transform coefficient of the macro block using the restored CSP.

The significant transform coefficient of the macro block, decoded by the significant transform coefficient decoder 405, has Y, U and V channel components. Components of the unused color channels are decoded as a value of 0.

With use of color channel components acquired from the decoded significant transform coefficient of the macro block, the residual decoder 205 outputs a restored enhancement layer residual picture, and Y, U and V channel components of the restored residual picture are added to Y, U and V channel components of the up-converted basement layer picture by the adder 207, and then output as a reconstructed enhancement layer picture, which is represented by decoded color channels.

Various examples of the CSP representation structure capable of dynamically responding to the omission of at least one color channel according to an exemplary embodiment are described below.

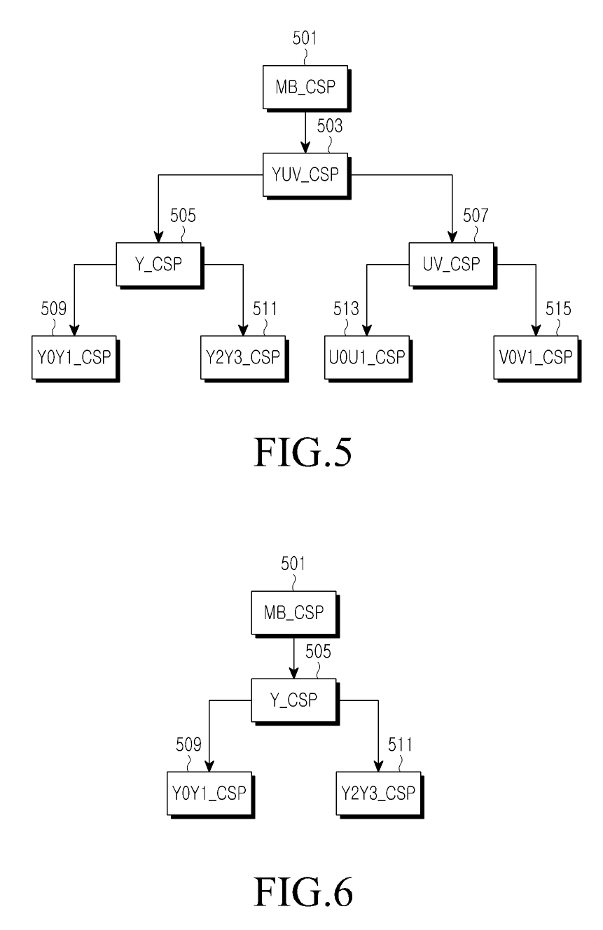

FIG. 5 shows a CSP representation structure in which all CSPs are hierarchically constructed from an MBMB-level according to an exemplary embodiment.

The CSP representation structure of FIG. 5 includes a plurality of CSP representation parts 501, 503, 505, 507, 509, 511, 513, and 515 for representing a CSP in each layer. The CSP converter 303 of FIG. 3 and the CSP restorer 403 of FIG. 4, respectively, convert and restore a CSP to have a structure including at least one color channel through a CSP representation part corresponding to at least one selected color channel according to an exemplary embodiment.

Referring to FIG. 5, an MB-level CSP representation part MB_CSP 501 is hierarchically connected to a plurality of CSP representation parts to represent the presence or absence of significant transform coefficients for a macro block or its pixel blocks of a predetermined size.

The MB-level CSP representation part MB_CSP 501 may selectively represent CSPs in the entire macro block by being hierarchically connected to a CSP representation part YUV_CSP 503 of Y, U and V channel blocks, a CSP representation part Y_CSP 505 of Y channel blocks corresponding to a luma block, a CSP representation part Y0Y1_CSP 509 of upper blocks Y0Y1 in the luma block, a CSP representation part Y2Y3_CSP 511 of lower blocks Y2Y3 in the luma block, a CSP representation part UV_CSP 507 of U and V channel blocks corresponding to a chroma block, a CSP representation part U0U1_CSP 513 of U channel blocks, and a CSP representation part V0V1_CSP 515 of V channel blocks.

The CSP representation part YUV_CSP 503 is represented by joint coding CSPs of the luma and chroma channel blocks. The CSP representation part Y_CSP 505 is represented by joint coding CSPs of the upper and lower blocks Y0Y1 and Y2Y3 in the luma block. The CSP representation part UV_CSP 507 is represented by joint coding CSPs of the U and V channel blocks U0U1 and V0V1. The CSP representation part Y0Y1_CSP 509 is represented by joint coding CSPs of upper blocks Y0Y1 in the luma block. The CSP representation part Y2Y3_CSP 511 is represented by joint coding CSPs of lower blocks Y2Y3 in the luma block.

In addition, the CSP representation part U0U1_CSP 513 is represented by joint coding CSPs of U channel blocks U0U1 in the case where a video format is, for example, 4:2:2. The CSP representation part V0V1_CSP 515 is represented by joint coding CSPs of V channel blocks V0V1 in the case where the video format is, for example, 4:2:2. If the video format is 4:2:0, the CSPs of the U and V channel blocks U0U1 and V0V1 are omitted. Although example of FIG. 5 is described based on the video format of 4:2:2, the same can be easily extended to the video format of 4:4:4. Examples of a CSP representation structure are shown in FIGS. 11 to 17, in which CSPs are hierarchically constructed in the case where the video format is extended to 4:4:4.

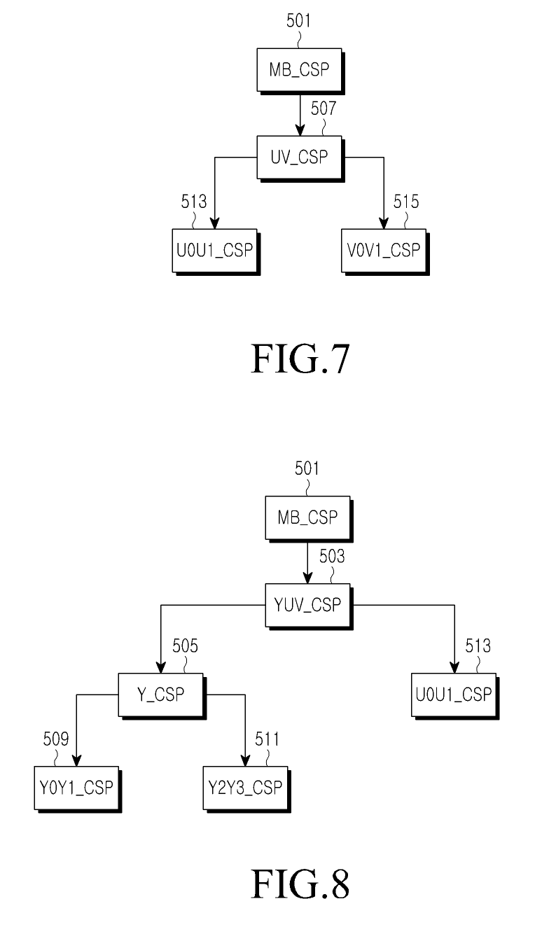

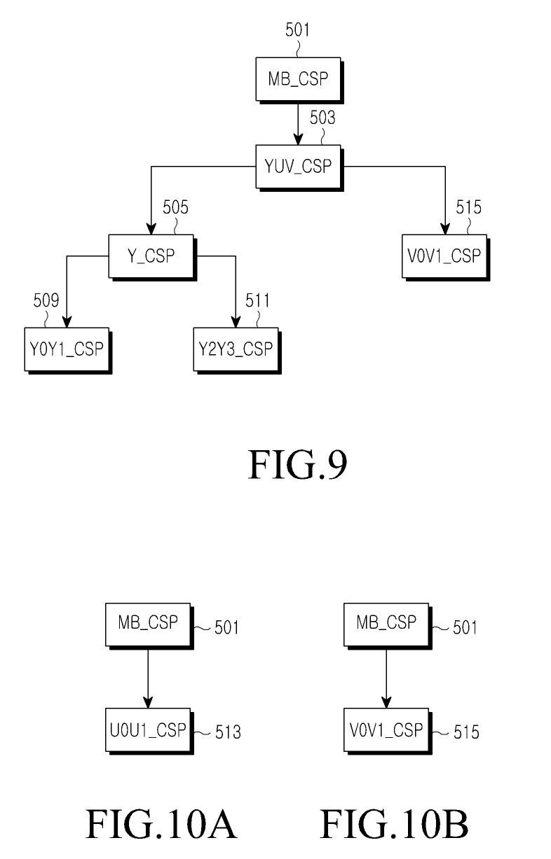

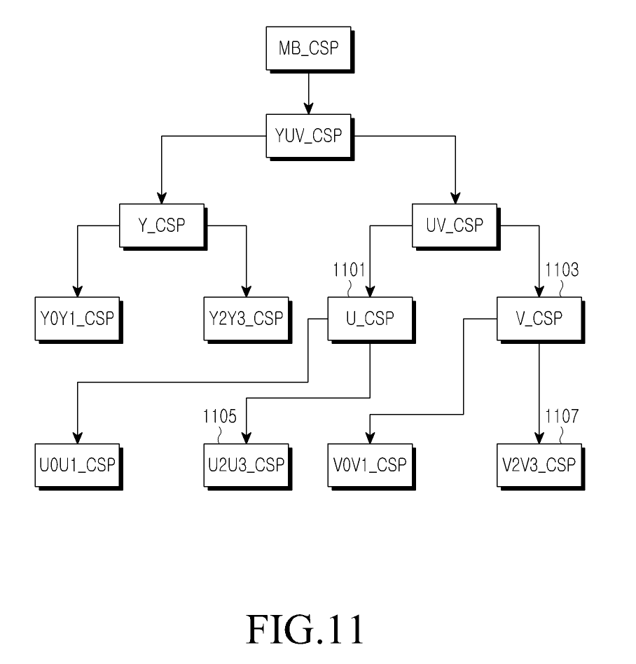

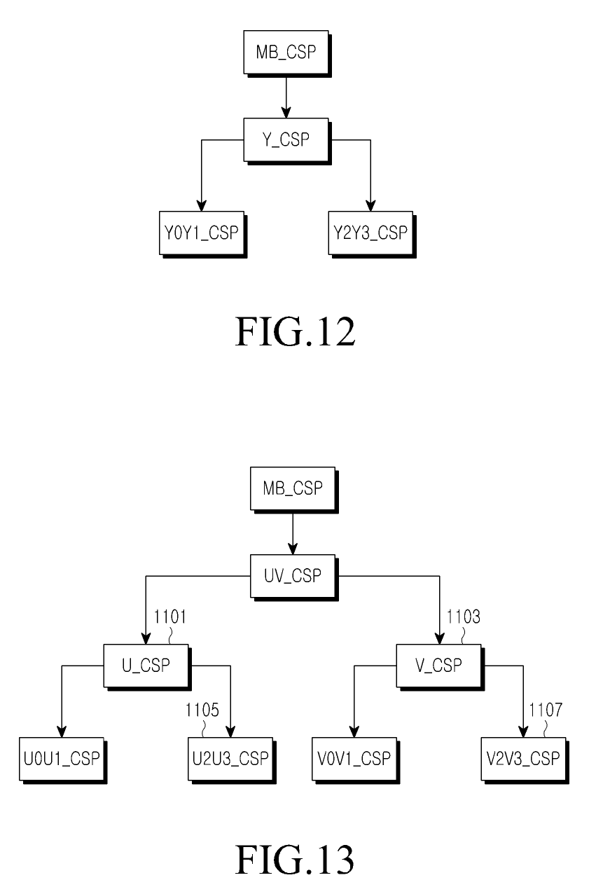

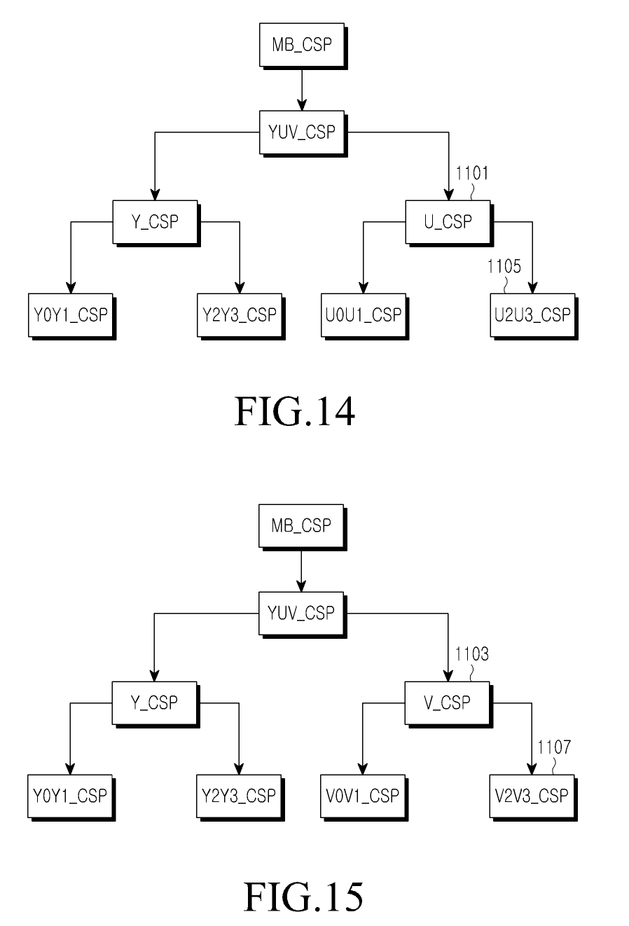

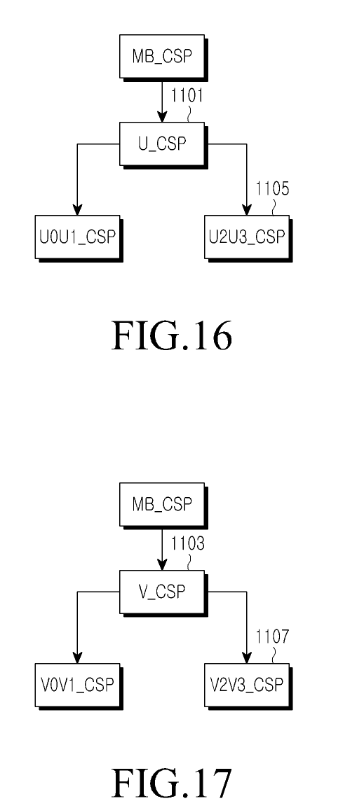

Now, with reference to FIGS. 6 to 10, a CSP representation structure according to an exemplary embodiment, is described in the case where at least one color channel is omitted in the enhancement layer of the hierarchical CSP representation structure and selective coding/decoding is performed. In FIG. 6, the MB-level CSP representation part MB_CSP 501 can be identified from an MB coded mode included in an MB header of the enhancement layer bitstream.

Examples of the CSP representation structures are illustrated in FIGS. 6 to 10 for four difference cases: 1) only the luma channels are selected (i.e., the chroma channel is omitted; see FIG. 6), 2) only the chroma channels are selected (i.e., the luma channel is omitted, see FIG. 7), 3) luma channels and one of chroma channels are selected (i.e., the V or U channel is omitted from the chroma channel, see FIGS. 8 and 9), and 4) no luma channels are selected and one of chroma channels is selected (i.e., not only the luma channel but also the chroma channel are omitted, see FIG. 10). If all color channels are selected, all CSP parts of FIG. 5 are coded. The CSP representation structures for the four different cases are described in detail below.

FIG. 6 shows a hierarchical CSP representation structure in which only luma channels are selected, according to an exemplary embodiment.

Referring to FIG. 6, the MB_CSP 501 determined from the header information of the macro block is identical to the representation Y_CSP 505 of luma channel blocks in YUV_CSP, and all chroma channels' information is skipped, so the YUV_CSP 503 is omitted in FIG. 6. In addition, because all of chroma channels' information is skipped, the CSP representations of the UV_CSP 507, the U0U1_CSP 513, and the V0V1_CSP 515 are omitted in FIG. 6. In this case, only Y_CSP 505 is restored to an MB-level CSP in the color channel decoder 400 of FIG. 4.

FIG. 7 shows a hierarchical CSP representation structure in which only chroma channels are selected, according to an exemplary embodiment.

Referring to FIG. 7, the MB_CSP 501 determined from the header information of the macro block is identical to the representation UV_CSP 507 of a chroma channel block in YUV_CSP. In this case, since luma channel information is skipped, the YUV_CSP 503 is omitted in FIG. 7. In addition, because all of the luma channels' information is skipped, the CSP representations of the Y_CSP 505, the Y0Y1_CSP 509, and the Y2Y3_CSP 511 are omitted in FIG. 7. In this case, only UV_CSP 507 is restored to an MB-level CSP in the color channel decoder 400 of FIG. 4.

FIG. 8 shows a hierarchical CSP representation structure in which the luma channels and only a U channel out of two chroma channels are selected, according to an exemplary embodiment. FIG. 9 shows a hierarchical CSP representation structure in which luma channels and only a V channel out of two chroma channels are selected, according to an exemplary embodiment.

In each of the CSP representation structures of FIGS. 8 and 9, the MB_CSP 501 determined from the header information of the macro block indicates CSPs of the luma channel blocks and chroma channel blocks in the macro block. The YUV_CSP 503 is represented by joint coding the Y_CSP 505 of luma channel blocks, and a CSP 513 or 515 of the U or V channel block selected from the chroma channels.

In the CSP representation structures of FIGS. 8 and 9, since all of the luma channels are selected, all of the Y_CSP 505, the Y0Y1_CSP 509, and the Y2Y3_CSP 511 of the luma channel blocks are represented. In the case of the chroma channels, since which channel is selected and which channel is omitted is set forth in a sequence or a header such as picture header, CSP information of the chroma channels in UV_CSP 507 is identical to the CSP representation of a selected one of the U and V channels in the YUV_CSP 503. Therefore, in the CSP representation structures of FIGS. 8 and 9, the UV_CSP 507, which specifies which of chroma channels has been coded in which way, shown in FIG. 5 is omitted.

FIG. 10 shows a hierarchical CSP representation structure in a case where no luma channel is selected and one of chroma channels is selected according to an embodiment of the present invention. Referring to FIG. 10, since the MB_CSP 501 determined from the header information of the macro block corresponds to the CSP information 513 (or 515) of one channel selected from the U and V channels of the chroma channels, the YUV_CSP 503, the Y_CSP 505, the Y0Y1_CSP 509, the Y2Y3_CSP 511 and the UV_CSP 507 are omitted in FIG. 5. If the video format is 4:2:2, only the U0U1_CSP 513 (FIG. 10A) or the V0V1_CSP 515 (FIG. 10B) is needed. If video format is 4:2:0, the MB_CSP 501 represents a CSP of the relevant chroma block.

FIGS. 11 to 17 show examples of a CSP representation structure in which CSPs are hierarchically constructed in the case where the video format is extended to 4:4:4.

Since an example of FIG. 11 corresponds to that of FIG. 5, a detailed description of CSP representation parts having the same names as those of FIG. 5 will be omitted.

The CSP representation structure of FIG. 11 includes a plurality of CSP representation parts processing CSP representation in each layer, and the CSP converter 303 of FIG. 3 and the CSP restorer 403 of FIG. 4 convert and restore CSPs, respectively, to have a structure in which at least one color channel is included using CSP representation parts corresponding to at least one color channel selected according to the present invention. Referring to FIG. 11, an MB-level CSP representation part MB_CSP is hierarchically connected to a plurality of CSP representation parts so as to represent the presence/absence of significant transform coefficients for a macro block or its pixel blocks of a predetermined size.

To be specific, an MB-level CSP representation part MB_CSP may be hierarchically connected to a CSP representation part YUV_CSP of Y, U and V channel blocks, a CSP representation part Y_CSP of the Y channel blocks corresponding to a luma block, a CSP representation part Y0Y1_CSP of an upper block Y0Y1 in the luma block, and a CSP representation part Y2Y3_CSP of a lower block in the luma block as shown in FIG. 11, making it possible to selectively represent CSPs in the entire macro block. In addition, the MB-level CSP representation part MB_CSP may be hierarchically connected to the CSP representation part YUV_CSP of the Y, U and V channel blocks, a CSP representation part UV_CSP of the U and V channel blocks corresponding to a chroma block, a CSP representation part U_CSP 1101 of the U channel block, a CSP representation part V_CSP 1103 of the V channel block, a CSP representation part U0U1_CSP of an upper block U0U1 in the U channel block, a CSP representation part U2U3_CSP 1105 of a lower block U2U3 in the U channel block, a CSP representation part V0V1_CSP of an upper block V0V1 in the V channel block, and a CSP representation part V2V3_CSP 1107 of a lower block V2V3 in the V channel block as shown in FIG. 11, making it possible to selectively represent CSPs in the entire macro block.

FIGS. 12 to 17 show examples capable of selectively representing CSPs in a case where the video format is extended to 4:4:4. U and V channel blocks are omitted in the example of FIG. 12, a Y channel block is omitted in the example of FIG. 13, a V channel block is omitted in the example of FIG. 14, a U channel block is omitted in the example of FIG. 15, Y and V channel blocks are omitted in the example of FIG. 16, and Y and U channel blocks are omitted in the example of FIG. 17. According to embodiments of the present invention, CSPs for the remaining selected channel blocks excepting the omitted channel blocks are joint-coded for CSP representation.

While exemplary embodiments have been shown and described, it will be understood by those skilled in the art that various changes in form and details may be made therein without departing from the spirit and scope of the inventive concept as defined by the appended claims and their equivalents.

What is claimed is:

1. A method for coding a color channel in a layered video coder, the method comprising:
if there is at least one color channel that can be skipped during coding of the color channel, converting a Coded Significant Pattern (CSP) of a macro block, which represents a structure of the color channel, into a CSP with a structure in which the at least one color channel is skipped; and
coding a significant transform coefficient of the macro block using the CSP represented in the structure in which the at least one color channel is skipped.

2. The method of claim 1, wherein the converting comprises coding the CSP of the macro block by jointly coding at least one color channel selected by excepting the skipped at least one color channel from the macro block.

3. The method of claim 1, further comprising converting the CSP representation structure of the macro block into a structure including at least one channel block of a luma channel block and two chroma channel blocks according to the skip of the at least one color channel.

4. The method of claim 1, further comprising converting the CSP representation structure of the macro block into a structure including one of two chroma channel blocks and a luma channel block according to the skip of the at least one color channel.

5. The method of claim 1, further comprising converting the CSP representation structure of the macro block into a structure including one of a U channel block and a V channel block of a chroma channel according to the skip of the at least one color channel.

6. The method of claim 1, wherein channel skip mode information indicating the skipped at least one color channel is included in a picture header.

7. The method of claim 1, wherein the CSP is applied to at least one video format of 4:2:2, 4:2:0, and 4:4:4.

8. An apparatus for coding a color channel in a layered video coder, the apparatus comprising:
a Coded Significant Pattern (CSP) converter which, if there is at least one color channel that can be skipped during coding of the color channel, converts a CSP of a macro block, which represents a structure of the color channel, into a CSP with a structure in which the at least one color channel is skipped; and
a significant transform coefficient coder which codes a significant transform coefficient of the macro block using the CSP represented in the structure in which the at least one color channel is skipped.

9. The apparatus of claim 8, wherein the CSP converter is configured to code the CSP of the macro block by jointly coding at least one color channel selected by excepting the skipped at least one color channel from the macro block.

10. The apparatus of claim 8, wherein the CSP converter is configured to convert the CSP representation structure of the macro block into a structure including at least one channel block of a luma channel block and two chroma channel blocks according to the skip of the at least one color channel.

11. The apparatus of claim 8, wherein the CSP converter is configured to convert the CSP representation structure of the macro block into a structure including one of two chroma channel blocks and a luma channel block according to the skip of the at least one color channel.

12. The apparatus of claim 8, wherein the CSP converter is configured to convert the CSP representation structure of the macro block into a structure including one of a U channel block and a V channel block of a chroma channel according to the skip of the at least one color channel.

13. The apparatus of claim 8, wherein channel skip mode information indicating the skipped at least one color channel is included in a picture header.

14. The method of claim 8, wherein the CSP is applied to at least one video format of 4:2:2, 4:2:0, and 4:4:4.

15. A method for decoding a color channel in a layered video decoder, the method comprising:
if at least one skipped color channel is detected from a received image, restoring a Coded Significant Pattern (CSP) of a macro block, which represents a structure of the color channel, into a CSP with a structure in which the at least one color channel is skipped; and
decoding a significant transform coefficient of the macro block using the restored CSP.

16. The method of claim 15, wherein the restoring comprises restoring a CSP of the macro block by jointly coding at least one color channel selected by excepting the skipped at least one color channel from the macro block.

17. The method of claim 15, further comprising restoring the CSP representation structure of the macro block into a structure including at least one channel block of a luma channel block and two chroma channel blocks according to the skipped at least one color channel.

18. The method of claim 15, further comprising restoring the CSP representation structure of the macro block into a structure including one of two chroma channel blocks and a luma channel block according to the skipped at least one color channel.

19. The method of claim 15, further comprising restoring the CSP representation structure of the macro block into a structure including one of a U channel block and a V channel block of a chroma channel according to the skipped at least one color channel.

20. The method of claim 15, wherein channel skip mode information indicating the skipped at least one color channel is included in a picture header.

21. The method of claim 15, wherein the CSP is applied to at least one video format of 4:2:2, 4:2:0, and 4:4:4.

22. An apparatus for decoding a color channel in a layered video decoder, the apparatus comprising:
a Coded Significant Pattern (CSP) restorer which if at least one skipped color channel is detected from a received image, restores a CSP of a macro block, which represents a structure of the color channel, into a CSP with a structure in which the at least one color channel is skipped; and
a significant transform coefficient decoder which decodes a significant transform coefficient of the macro block using the restored CSP.

23. The apparatus of claim 22, wherein the CSP restorer is configured to restore a CSP of the macro block by jointly coding at least one color channel selected by excepting the skipped at least one color channel from the macro block.

24. The apparatus of claim 22, wherein the CSP restorer is configured to restore the CSP representation structure of the macro block into a structure including at least one channel block of a luma channel block and two chroma channel blocks according to the skipped at least one color channel.

25. The apparatus of claim 22, wherein the CSP restorer is configured to restore the CSP representation structure of the macro block into a structure including one of two chroma channel blocks and a luma channel block according to the skipped at least one color channel.

26. The apparatus of claim 22, wherein the CSP restorer is configured to restore the CSP representation structure of the macro block into a structure including one of a U channel block and a V channel block of a chroma channel according to the skipped at least one color channel.

27. The apparatus of claim 22, wherein channel skip mode information indicating the skipped at least one color channel is included in a picture header.

28. The method of claim 22, wherein the CSP is applied to at least one video format of 4:2:2, 4:2:0, and 4:4:4.
